(19) United States
(12) Patent Application Publication
(10) Pub. No.: US 2015/0178755 A1
(43) Pub. Date: Jun. 25, 2015

(54) SYSTEMS AND METHODS FOR CONSUMER DRIVEN MARKETING

(71) Applicant: Lanny Barroso, Tamarac, FL (US)

(72) Inventor: Lanny Barroso, Tamarac, FL (US)

(21) Appl. No.: 14/135,403

(22) Filed: Dec. 19, 2013

(51) Int. Cl. G06Q 30/02

(52) U.S. Cl. CPC G06Q 30/0217

(57) ABSTRACT

A method for consumer driven marketing provide a relationship marketing system that enables a consumer to receive benefits from a merchant for marketing to potential consumer in at least one relationship network. The consumer obtains the system by downloading onto a communication device. The consumer visits the merchant to purchase a product or service. The consumer captures images and provides text on the communication device about the product and then distributes the image and text throughout relationship networks. The feedback from the potential consumer is the substance of the marketing effort, as the potential customers receive validation of the product from a trusted, known consumer. The merchant converts the feedback into incentives for the consumer. The incentives are defined and distributed by the merchant. The consumer may receive all the incentives, or share them with the potential consumer to further leverage the incentives for additional marketing.

### BACKGROUND OF THE INVENTION

1. Field of the Invention

This invention relates to consumer driven marketing, and more particularly relates to a system and method for a merchant to incentivize marketing for a consumer, where the consumer leads the marketing effort for a product or service and is rewarded with incentives from the merchant when potential consumers provide feedback.

2. Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is commonly known that selling products and services is a multi-stage process requiring at least two parties. Typically, a sale is the act of selling a product or service in return for money or other compensation. The merchant or supplier—the provider of the goods or services—completes a sale in response to an acquisition or to an appropriation or to a request. There follows the passing of ownership in the item, and the application and due settlement of a price, the obligation for which arises due to the seller's requirement to pass ownership.

Typically, marketing involves advertising or otherwise promoting the sale of a product or service. In some instances, marketers attempt to identify the set of decision makers most likely to make a purchase. Another marketing technique is to give free samples of the product or service. But even after receiving samples, the merchant remain disproportionately burdened by costs.

It is known that selling is the final stage in marketing, which also includes pricing, promotion, positioning and product. A marketing department has the goals of increasing the desirability and value to the customer and increasing the number and engagement of interactions between potential customers and the merchant. Achieving this goal may involve the marketer using promotional techniques such as advertising, sales promotion, publicity, and public relations, creating new sales channels, or creating new products. It can also include bringing the potential consumer to visit the merchant's website for more information, or to contact the merchant for more information, or to interact with the merchant via social media such as Twitter, Facebook, and blogs.

It is known that relationship marketing is a form of marketing developed from direct response marketing campaigns which emphasizes customer retention and satisfaction, rather than a dominant focus on sales transactions. As a practice, relationship marketing differs from other forms of marketing in that it recognizes the long term value of customer relationships and extends communication beyond intrusive advertising and sales promotional messages. With the growth of the internet and mobile platforms, relationship marketing has continued to evolve and move forward as technology opens more collaborative and social communication channels. This includes tools for managing relationships with customers that move beyond simple demographic and customer service data.

Often, a contest involves a race, conflict, or other competition between rivals, as for a prize. A contest based on the product or service may involve trivial questions and puzzles. Such a competitive event, utilized in a marketing scheme, and electronically presented by a marketer may help distinguish the marketer from other marketing techniques.

In many instances, marketing techniques are expensive and do not allow the merchant to reach enough potential consumers. The merchant can utilize technology, known relationships, and games for marketing on social networks, such as Facebook and Twitter. A present consumer often enjoys incentives from the merchant.

In view of the foregoing, it is clear that these traditional techniques are not perfect and leave room for more optimal approaches.

### SUMMARY OF THE INVENTION

From the foregoing discussion, it should be apparent that a need exists for a system and method for a merchant to incentivize a consumer to perform relationship marketing, where the consumer leads the marketing effort for a product or service. The system and method enables the consumer to be rewarded with incentives from the merchant when potential consumers provide feedback. The present invention has been developed in response to the present state of the art; and, in particular, in response to the problems and needs in the art that have not yet been fully solved by currently available methods, systems and apparatus, and that overcome many or all of the above-discussed shortcomings in the art. Accordingly, the present invention has been developed to provide a consumer driven marketing system and method that allows a merchant to incentivize marketing efforts of consumer, such as marketing a product or service through social media and other relationship networks.

In one embodiment of the present invention, the consumer driven marketing system and method provides a marketing and advertising method that enables a merchant to market a product or service vicariously through a consumer, rather than through traditional marketing methods. The merchant leverages relationships and networks between the consumer and a potential consumer in at least one relationship network. In this manner, the merchant may promote a product or service vicariously through the consumer, rather than through traditional direct efforts. Beneficially, the consumer also receives incentives to market the product or service through merchant defined incentives, such as discounts, free products or services, and bonus points. The potential consumer also benefits by being exposed to the product or service from a trusted person such as the consumer in the at least one relationship network.

In one embodiment of the present invention, a method for consumer driven marketing may provide a relationship marketing system that enables a consumer to receive benefits from a merchant for marketing to potential consumer in at least one relationship network. The consumer captures images and provides text about the product and then distributes the image and text throughout the at least one relationship network. The feedback from the potential consumer is the substance of the marketing effort. The merchant converts the feedback into incentives for the consumer. The incentives are defined and distributed by the merchant. Additionally, the consumer may receive all the incentives, or share them with the potential consumer to further leverage the incentives for additional marketing.

In some embodiments, the method for consumer driven marketing may include an initial Step of obtaining a system for consumer driven marketing on a communication device. The system may include a software application that enables the consumer and the merchant to coordinate and communicate the marketing effort. The consumer may obtain the system by downloading the software application on a communication device. Those skilled in the art will recognize that a smart phone provides every function that the present system and method requires for consumer driven marketing, including, without limitation, accessing a social network, capturing an image, communicating between the consumer and potential consumer, accessing feedback from the potential consumer, and distributing and using the incentives. The software application is configured to generate revenue based on the quantity of visits the consumer or potential consumer make to the software application or a merchant website that links to the software application.

In some embodiments, a next Step may include the consumer visiting the merchant. The consumer may frequent the merchant regularly, or be on a first visit. In any case, to view and access the product or service, the consumer must visit the merchant, either in person, or in some embodiments, online. The incentive provided by the merchant helps retain the consumer and incentivize the consumer for performing relationship marketing.

A Step further includes the consumer generating an image or forming text for a product or service. The consumer may form a still picture, a video, or write a comment about the product or service to potentially share with a potential consumer on the at least one relationship network. In one example, the consumer utilizes a smart phone to capture a digital image of a plate of food in a restaurant.

In some embodiments, another Step comprises distributing the image or text onto the at least one relationship network. The consumer may download the image or text onto the at least one relationship network, such as an internet social network. This is the essence of the relationship marketing because the at least one relationship network includes potential consumers who know and trust the judgment of the consumer. The potential consumer is also exposed to the product or service, maybe for the first time. The reach of the merchant, is thereby exponentially increased through the social network of the consumer. Additionally, as the potential consumer converts into a new consumer, the relationship marketing may continue with increased effect. In some embodiments, the at least one relationship network may include, without limitation, Facebook, Instagram, Twitter, and Snapshot. However, the at least one relationship network may also include family websites, email lists, company picnics, and any social structure made up of a set of social actors, such as individuals or organizations, and a set of the dyadic ties between the social actors.

In some embodiments, a Step may include receiving feedback from the potential consumer. The feedback from the potential consumer is the substance of the marketing effort. The merchant converts the feedback into incentives, which are defined by the merchant. The feedback may include, without limitation, “Likes” and “Follows” from Facebook, reviews, comments, and new social “friendship” formations. The merchant may also view and interact in the feedback. For example, a negative feedback may be quickly followed by an apology or reason from the merchant. The potential consumer may understand the reasons for the inferior product or service at that point. In some embodiments, the merchant may quantify the feedback for statistical studies and more sophisticated marketing.

The method may include a further Step of converting the feedback into an incentive. The merchant determines the incentive and the methodology for distributing the incentive and states the type and amount of incentives appropriate for each type of feedback. This may be distributed for viewing in an incentive schedule. In some embodiments, the merchant may provide information about the incentives, such as listing the number of “Likes” on Facebook required to receive a free product or service. The application may also state the incentive schedule. The merchant may design the incentive to create additional marketing and purchases from the consumer and the potential consumer.

A final Step includes rewarding the consumer with the incentive. The incentive may be given to the consumer through a digital process by depositing into a consumer account, or through the software application of the system. However, in other embodiments, the consumer may physically appear at the merchant to receive the incentive. The merchant rewards the consumer with the incentive as dictated in the incentive schedule. The incentive may include, without limitation, coupons, discounts, free products or services, and bonus points. In one embodiment, the consumer may select the type of incentive from a predetermined incentive list. In one alternative embodiment, the consumer may choose to share the incentive with the potential consumer on the hopes that additional feedback and incentives may be generated.

In one aspect, the method for consumer driven marketing provides an incentive to a consumer to market a product or service through a relationship network of potential consumers, comprising the steps of:

obtaining a system for consumer driven marketing on a communication device;

visiting a merchant;

generating an image or a text for a product or service;

distributing the image or text to at least one relationship network;

receiving feedback on the image or text from a potential consumer;

converting the feedback into an incentive; and

rewarding the consumer with the incentive.

In another aspect, the merchant leverages the relationship network of the consumer to increase the reach for marketing the product or service.

In another aspect, the consumer receives an incentive for distributing an image or text of the product or service, and then reserving a predetermined amount and type of feedback from the potential consumer on the consumer's relationship network.

In another aspect, the potential consumer views and experiences the product or service through the experience of the consumer. The potential consumer also enhances the social interaction with the consumer through the feedback of the product or service.

In yet another aspect, the system for consumer driven marketing is played as a game with rules, incentives, and goals.

In yet another aspect, the software application includes a personalized login section for the consumer, whereby the merchant can monitor the amount of visits by the consumer.

In yet another aspect, the merchant regulates the incentives and rules for receiving incentives. For example, a predetermined number of Likes on Facebook convert into a predetermined incentive, based on an incentive schedule. The merchant may also obtain feedback for additional marketing.

In yet another aspect, the consumer receives incentives for garnering feedback in the at least one relationship network, and also for referring the potential consumer to the merchant by sharing the incentive.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a flowchart diagram of a method for consumer driven marketing, in accordance with an embodiment of the present invention;

FIG. 2 illustrates a work diagram of a system for consumer driven marketing, in accordance with an embodiment of the present invention; and

FIG. 3 illustrates a block diagram depicting an exemplary client/server system which may be used by an exemplary web-enabled/networked, in accordance with an embodiment of the present invention.

### DETAILED DESCRIPTION OF THE INVENTION

The foregoing summary, as well as the following detailed description of certain embodiments of the subject matter set forth herein, will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B.

In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense, and the scope of the subject matter disclosed herein is defined by the appended claims and their equivalents. In the description that follows, like numerals or reference designators will be used to refer to like parts or elements throughout. In this document, the terms “a” or “an” are used, as is common in patent documents, to include one or more than one. In this document, the term “or” is used to refer to a nonexclusive or, unless otherwise indicated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

In one embodiment of the present invention, a method 100 for consumer driven marketing is disclosed that provides an incentive laden, consumer driven marketing approach. This novel marketing method enables a merchant 202 to leverage incentives 214 against potential consumers 206 that the consumer 204 may know through at least one relationship network 208. A merchant may be a restaurant and/or a retail store and/or a beauty related business and/or a grocery store or the like.

In some embodiments, the method 100 enables the merchant 202 to market a product or service 210 vicariously through a consumer 204, rather than through traditional marketing methods. The merchant 202 leverages relationships and networks 208 between the consumer 204 and a potential consumer 206 in at least one relationship network 208. In this manner, the merchant 202 may promote a product or service 210 vicariously through the consumer 204, rather than through traditional direct efforts. Beneficially, the consumer 204 also receives an incentive 214 to market the product or service 210 through merchant defined incentives 214, such as discounts, free products or services, and bonus points. The potential consumer 206 also benefits by being exposed to the product or service 210 from a trusted person such as the consumer 204 in the at least one relationship network 208.

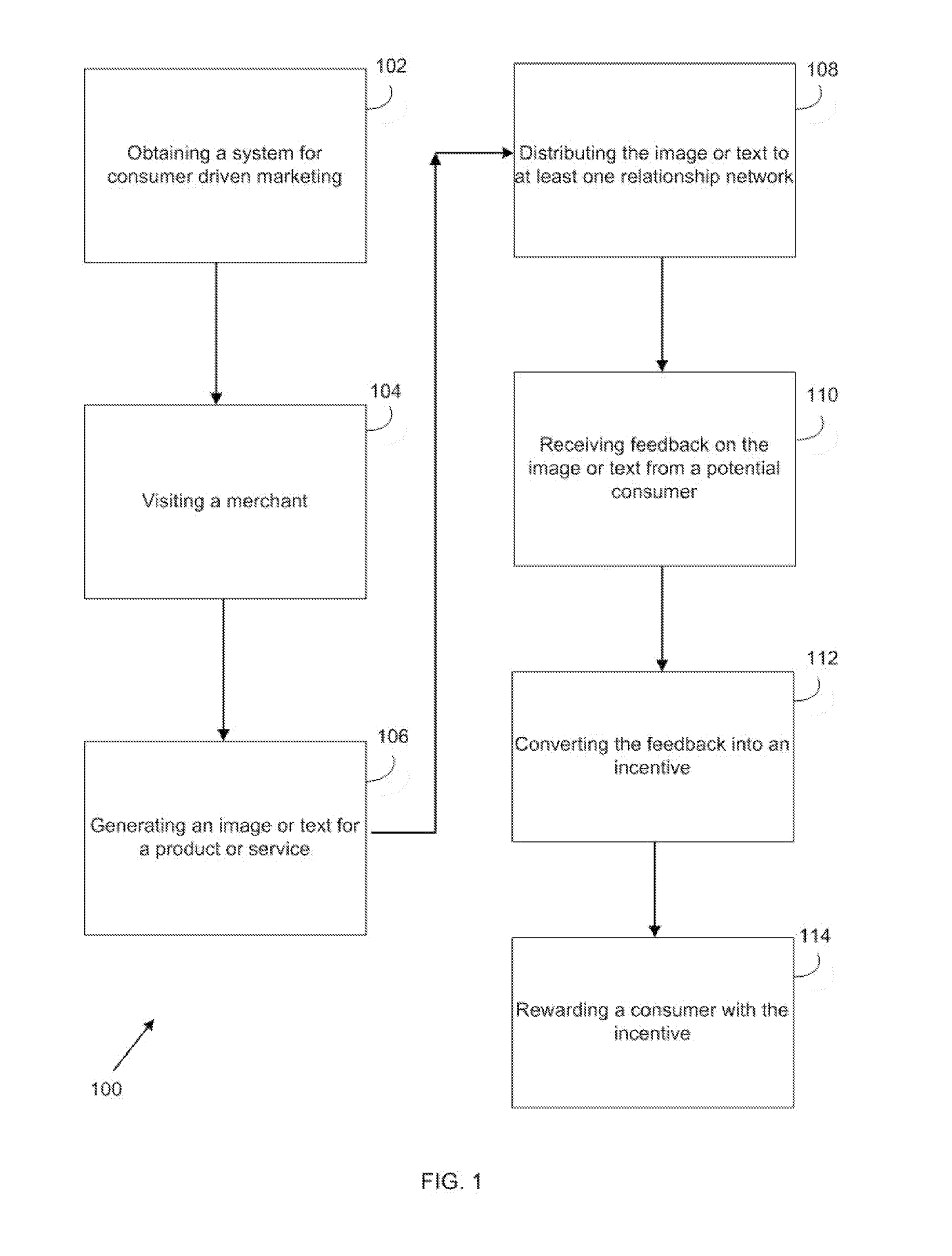

The method 100 for consumer driven marketing, as referenced in FIG. 1, serves to incentivize a consumer 204 to perform marketing activities to at least one known and familiar potential consumer 206, with the help of at least one relationship network 208. The steps for the method 100 comprise an initial Step 102 obtaining a system 200 for consumer driven marketing on a communication device 216. For example, the communication device may be a portable electronic device such as a smart phone, tablet, or the like. The system 200 may include a software application that enables the consumer 204 and the merchant 202 to coordinate and communicate the marketing effort. The consumer 204 may obtain the system 200 by downloading the software application on a communication device 216. Those skilled in the art will recognize that a smart phone provides every function that the present system 200 and method requires for consumer driven marketing, including, without limitation, accessing a social network 208, capturing an image, communicating between the consumer 204 and the potential consumer 206, accessing feedback 212 from the potential consumer 206, and distributing and using the incentives 214. The software application is configured to generate revenue based on the quantity of visits the consumer 204 or potential consumer 206 make to the software application or a merchant website that links to the software application.

In one example of the consumer 204 accessing the system 200 through a software application, the consumer 204 initially logs in through the communication device 216. A password may be required to do so. The consumer 204 may also log in with Facebook log in information, whereby Facebook and the system 200 overlap. In one embodiment, a bar code displays at the start of the log in. The consumer 204 may scan the bar code and be greeted, such as “Welcome Lanny”. The bar code may allow a user to scan and enter the game instantaneously. Also in one embodiment, the bar code scanned by a third party may allow the consumer 204 to receive rewards. In another embodiment, the system installed on the communication device may generate on the fly bar code to easily communicate, user information, location information, reward information, information regarding a merchant, initial consumer rewards, and the like.

A section on the software application may include a “How to Play” button. This appears if the system 200 is configured as a game. The software application may monitor and tally the visits by the consumer 204 for distributing the incentives accordingly and for additional marketing efforts by the merchant 202. In one alternative embodiment, the software application may incorporate a “Casino” theme, or a “Wheel of Fortune” theme.

In some embodiments, a next Step 104 may include the consumer 204 visiting the merchant 202. The consumer 204 may frequent the merchant 202 regularly, or be on a first visit. In any case, to view and access the product or service 210, the consumer 204 must visit the merchant 202, either in person, or in some embodiments, online. The incentive 214 provided by the merchant 202 helps retain the consumer 204 and incentivize the consumer 204 for performing relationship marketing.

A Step 106 further includes the consumer 204 generating an image or forming text for the product or service 210. The consumer 204 may form a still picture, a video, or write a comment about the product or service 210 to potentially share with a potential consumer 206 on the at least one relationship network 208. In one example, the consumer 204 utilizes a smart phone to capture a digital image of a plate of food in a restaurant. For example, the consumer 206 may capture media of a plate of food at a restaurant or any image of the merchant. The consumer 204 may also take a self image with the product or service 210 to create greater association.

In some embodiments, another Step 108 comprises distributing the image or text onto the at least one relationship network 208. The consumer 204 may download the image or text onto the at least one relationship network 208, such as an internet social network 208. This is the essence of the relationship marketing because the at least one relationship network 208 includes a potential consumer 206 who knows and trusts the judgment of the consumer 204. The potential consumer 206 is also exposed to the product or service 210, maybe for the first time. The reach of the merchant 202, is thereby exponentially increased through the social network 208 of the consumer 204. Additionally, as the potential consumer 206 converts into a new consumer, the relationship marketing may continue with increased effect. In some embodiments, the at least one relationship network 208 may include, without limitation, Facebook, Instagram, Twitter, and Snapshot. However, the at least one relationship network 208 may also include family websites, email lists, company picnics, and any social structure made up of a set of social actors, such as individuals or organizations, and a set of the dyadic ties between the social actors.

In some embodiments, a Step 110 may include receiving feedback 212 from the potential consumer 206. The feedback 212 from the potential consumer 206 is the substance of the marketing effort. The merchant 202 converts the feedback 212 into incentives 214, which are defined by the merchant 202. The feedback 212 may include, without limitation, “Likes” and “Follows” from Facebook, reviews, comments, and new social “friendship” formations. The merchant 202 may also view and interact in the feedback 212. For example, a negative feedback may be quickly followed by an apology or reason from the merchant 202. The potential consumer 206 may understand the reasons for the inferior product or service 210 at that point. In some embodiments, the merchant 202 may quantify the feedback 212 for statistical studies and more sophisticated marketing.

The method 100 may include a further Step 112 of converting the feedback 212 into an incentive 214. The merchant 202 determines the incentive 214 and the methodology for distributing the incentive 214 and states the type and amount of incentives 214 appropriate for each type of feedback 212. This may be distributed for viewing in an incentive schedule. For example, without limitation, the merchant 202 may require that the consumer 204 take one image of the product or service 210 per visit to redeem the incentive 214. The merchant 202 may also set a time limit for receiving the feedback 212.

In some embodiments, the merchant 202 may provide information about the incentive 214, such as listing the number of “Likes” on Facebook required to receive a free product or service 210. For example, without limitation a “Like” on Facebook is converted into the incentive 214 of discounts on food. If a consumer 204 receives 20-40 likes, the incentive 214 is one free desert of $7.00 or less. If the consumer 204 receives 40-60 likes, the incentive 214 is one free appetizer of $10.00 or less. If the consumer 204 receives 60-100 likes, the incentive is one free entree of $15.00 or less.

Additionally, the merchant 202 may design the incentive 214 to create additional marketing and purchases from the consumer 204 and the potential consumer 206. The merchant 202 may also form the rules for receiving the incentive 214. Some examples of rules set by the merchant 202 may include, without limitation:

The image or text that that receives the most amount of “Likes” on Facebook will be honored as a discount for the next visit;

A restaurant will not give money back if the consumer 204 orders something of less value than the coupon;

The restaurants redeem multiple coupons for a group of consumers 204 and potential consumers 206 at the same table that request split checks. Otherwise, only the amount offered will be honored and taken off the check and the remaining price will be paid by the consumer 204 and the potential consumer 206 who want to split the check; and

The restaurant menu is incorporated on the software application. From the communication device 216, the consumer 204 can choose the food item along with the image of the food item. This documentation helps keep track of what the consumer 204 particularly enjoys to eat. Those skilled in the art will recognize that many of the above stated rules will help food lovers a chance to look at what is served at the restaurant, if they have never been there or have a chance to look at a food item they have never ordered at a restaurant they frequently visit.

A final Step 114 includes rewarding the consumer 204 with the incentive 214. The incentive 214 may be given to the consumer 204 through a digital process by depositing into a consumer account, or through the software application of the system 200. However, in other embodiments, the consumer 204 may physically appear at the merchant 202 to receive the incentive 214. The merchant 202 rewards the consumer 204 with the incentive 214 as dictated in the incentive schedule. The incentive 214 may include, without limitation, coupons, discounts, free products or services, and bonus points. In one embodiment, the consumer 204 may select the type of incentive 214 from a predetermined incentive list. In one alternative embodiment, the consumer 204 may choose to share the incentive 214 with the potential consumer 206 on the hopes that additional feedback 212 and incentive 214s may be generated.

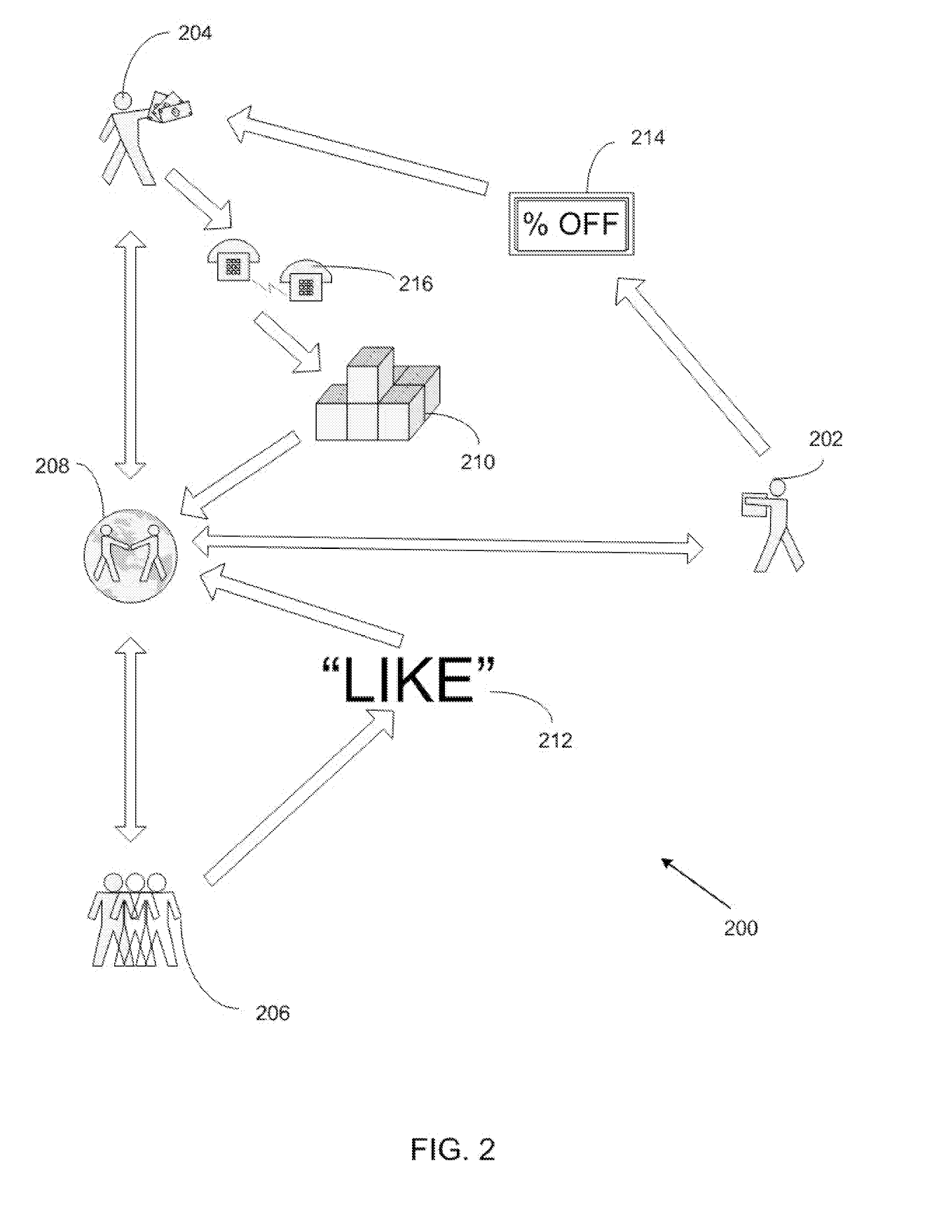

FIG. 2 illustrates a work diagram of a system 200 for consumer driven marketing, in accordance with an embodiment of the present invention. The system 200 may include a merchant 202, a consumer 204, and a potential consumer 206 that interact through at least one relationship network 208 and a software application to market a product or service 210 for receiving incentive 214. In this manner, the consumer 204 may enhance the marketing function, and the potential consumer 206 may experience the product or service 210 for the first time through a trusted source, such as the consumer 204 rather than an unknown source, such as the merchant 202.

In some embodiments, the system 200 may provide a relationship marketing system 200 that enables the consumer 204 to receive benefits from the merchant 202 for marketing to potential consumer 206 in at least one relationship network 208. The consumer 204 captures images and provides text about the product or service 210 and then distributes the image and text throughout the at least one relationship network 208. The feedback 212 from the potential consumer 206 is the substance of the marketing effort. The merchant 202 converts the feedback 212 into incentives 214 for the consumer 204. The incentives 214 are defined and distributed by the merchant 202. Additionally in one alternative embodiment, the consumer 204 may receive all the incentives 214, or share them with the potential consumer 206 to further leverage the incentives 214 for additional marketing. In yet another embodiment, the consumer 204 may also receive the incentive 214 for referring the potential consumer 206 to the product or service 210, a merchant 202 website, a social network for the product or service 210, and a software application for consumer driven marketing.

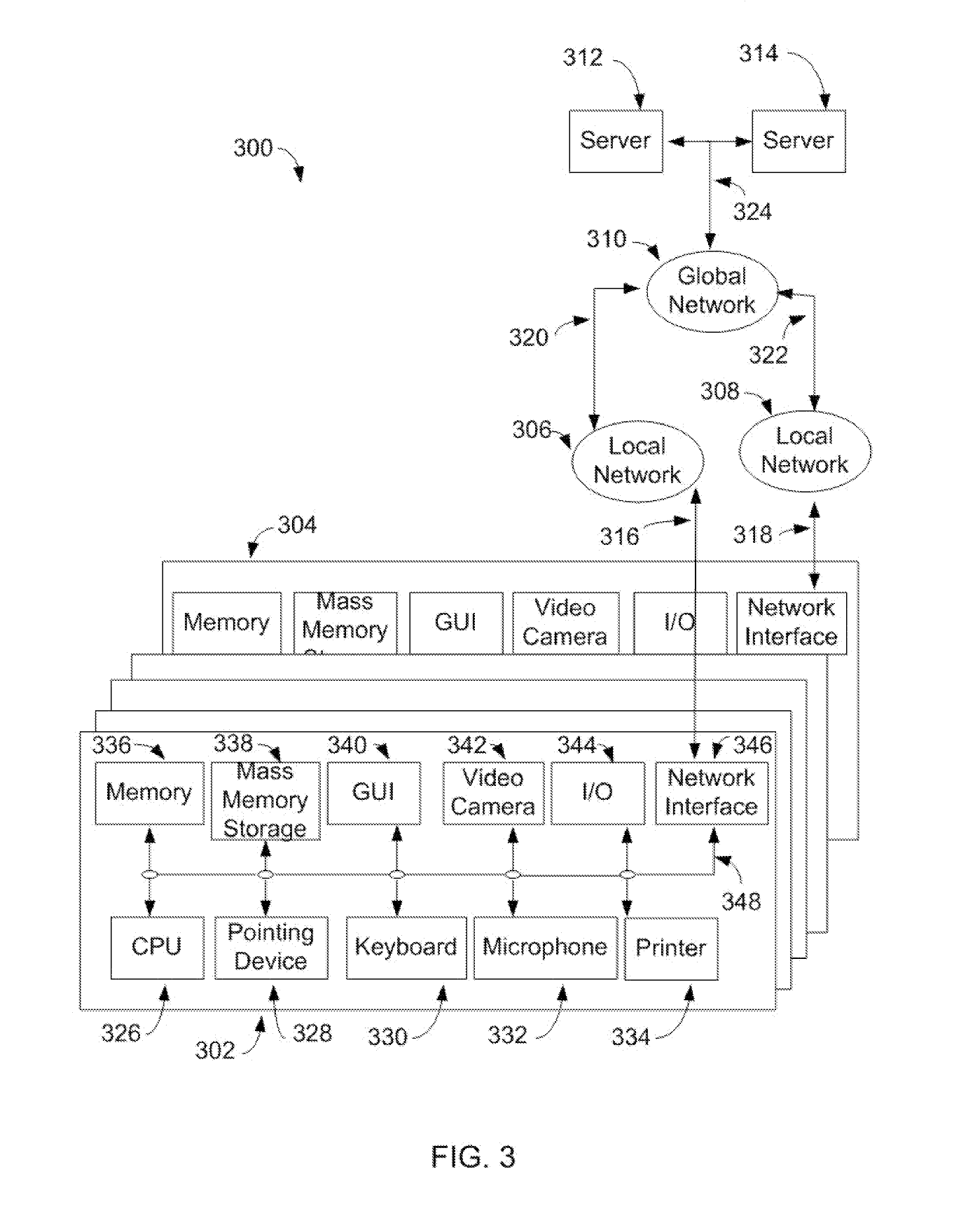

FIG. 3 is a block diagram depicting an exemplary client/server system which may be used by an exemplary web-enabled/networked embodiment of the present invention. In the present invention, a communication system 300 includes a multiplicity of clients with a sampling of clients denoted as a client 302 and a client 304, a multiplicity of local networks with a sampling of networks denoted as a local network 306 and a local network 308, a global network 310 and a multiplicity of servers with a sampling of servers denoted as a server 312 and a server 314.

Client 302 may communicate bi-directionally with local network 306 via a communication channel 316. Client 304 may communicate bi-directionally with local network 308 via a communication channel 318. Local network 306 may communicate bi-directionally with global network 310 via a communication channel 320. Local network 308 may communicate bi-directionally with global network 310 via a communication channel 322. Global network 310 may communicate bi-directionally with server 312 and server 314 via a communication channel 324. Server 312 and server 314 may communicate bi-directionally with each other via communication channel 324. Furthermore, clients 302, 304, local networks 306, 308, global network 310 and servers 312, 314 may each communicate bi-directionally with each other.

In one embodiment, global network 310 may operate as the Internet. It will be understood by those skilled in the art that communication system 300 may take many different forms. Non-limiting examples of forms for communication system 300 include local area networks (LANs), wide area networks (WANs), wired telephone networks, wireless networks, or any other network supporting data communication between respective entities.

Clients 302 and 304 may take many different forms. Non-limiting examples of clients 302 and 304 include personal computers, personal digital assistants (PDAs), cellular phones and smartphones.

Client 302 includes a CPU 326, a pointing device 328, a keyboard 330, a microphone 332, a printer 334, a memory 336, a mass memory storage 338, a GUI 340, a video camera 342, an input/output interface 344 and a network interface 346.

CPU 326, pointing device 328, keyboard 330, microphone 332, printer 334, memory 336, mass memory storage 338, GUI 340, video camera 342, input/output interface 344 and network interface 346 may communicate in a unidirectional manner or a bi-directional manner with each other via a communication channel 348. Communication channel 348 may be configured as a single communication channel or a multiplicity of communication channels.

CPU 326 may be comprised of a single processor or multiple processors. CPU 326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 336 is used typically to transfer data and instructions to CPU 326 in a bi-directional manner. Memory 336, as discussed previously, may include any suitable computer-readable media, intended for data storage, such as those described above excluding any wired or wireless transmissions unless specifically noted. Mass memory storage 338 may also be coupled bi-directionally to CPU 326 and provides additional data storage capacity and may include any of the computer-readable media described above. Mass memory storage 338 may be used to store programs, data and the like and is typically a secondary storage medium such as a hard disk. It will be appreciated that the information retained within mass memory storage 338, may, in appropriate cases, be incorporated in standard fashion as part of memory 336 as virtual memory.

CPU 326 may be coupled to GUI 340. GUI 340 enables a user to view the operation of computer operating system and software. CPU 326 may be coupled to pointing device 328. Non-limiting examples of pointing device 328 include computer mouse, trackball and touchpad. Pointing device 328 enables a user with the capability to maneuver a computer cursor about the viewing area of GUI 340 and select areas or features in the viewing area of GUI 340. CPU 326 may be coupled to keyboard 330. Keyboard 330 enables a user with the capability to input alphanumeric textual information to CPU 326. CPU 326 may be coupled to microphone 332. Microphone 332 enables audio produced by a user to be recorded, processed and communicated by CPU 326. CPU 326 may be connected to printer 334. Printer 334 enables a user with the capability to print information to a sheet of paper. CPU 326 may be connected to video camera 342. Video camera 342 enables video produced or captured by user to be recorded, processed and communicated by CPU 326.

CPU 326 may also be coupled to input/output interface 344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 326 optionally may be coupled to network interface 346 which enables communication with an external device such as a database or a computer or telecommunications or internet network using an external connection shown generally as communication channel 316, which may be implemented as a hardwired or wireless communications link using suitable conventional technologies. With such a connection, CPU 326 might receive information from the network, or might output information to a network in the course of performing the method steps described in the teachings of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions, types of materials and coatings described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. One or more computer storage media storing computer-usable instructions, that when used by one or more computing devices, causes the computing devices to perform a method for consumer driven marketing comprising:
(a) obtaining a system for consumer driven marketing on a communication device;
(b) visiting a merchant;
(c) generating an image or a text for a product or service;
(d) distributing the image or text to at least one relationship network;
(e) receiving feedback on the image or text from a potential consumer;
(f) converting the feedback into an incentive; and
(g) rewarding the consumer with the incentive.

2. The method of claim 1, in which the consumer driven marketing comprises relationship marketing between the consumer and the potential consumer on at least one social network.

3. The method of claim 1, in which (a) further comprises downloading a software application, the software application being configured to operate the system for consumer driven marketing and operatively linking the merchant, the consumer, the potential consumer, and the at least one relationship network.

4. The method of claim 1, in which the software application is configured to generate revenue based on the quantity of visits the consumer or potential consumer make to the software application and/or a merchant website that links to the software application.

5. The method of claim 1, further comprising providing a scan the bar code in at least the merchant's place and the system on a communication device.

6. The method of claim 1 further comprises generating, on the fly, bar code to easily communicate, user information, location information, reward information, information regarding a merchant, initial consumer rewards, and the like, or any combination thereof.

7. The method of claim 1, in which step (b) further comprises physically appearing at the merchant to purchase the product or service.

8. The method of claim 1, in which step (d) further comprises uploading the image or text on an internet social site.

9. The method of claim 1, in which the at least one relationship network comprises Facebook, Instagram, Twitter, Snapshot, and the like, or any combination thereof.

10. The method of claim 1, in which step (e) further comprises receiving a recognition on the social media for uploaded media of merchant's product/s or service/s.

11. The method of claim 1, in which step (f) further comprises generating an incentive schedule based on the quantity and type of feedback from social network.

12. The method of claim 1, in which step (f) further comprises providing a reward/incentive to the consumer when a predetermined criteria is met on the social media on the uploaded media.

13. The method of claim 1, in which the incentive comprises a discount, and/or a coupon, and/or a free product or service, and/or bonus points.

14. The method of claim 1, in which step (g) further comprises the merchant emailing the consumer a coupon, and/or the software application displaying a digital coupon in a consumer account.

15. The method of claim 1, in which step (g) further comprises the merchant setting predetermined rules for distributing the incentive.

16. The method of claim 1, in which the method comprises an additional step (h) of the consumer sharing the incentive with the potential consumer, wherein additional feedback from the potential consumer increases the incentives for the consumer.

17. The method of claim 1, in which step (h) further comprises the incentive having a code, the code being specific to the consumer, wherein if the incentive is redeemed by a predetermined number of potential consumers, the consumer receives additional incentives.

18. A consumer driven marketing system comprising:
(a) A non-transitory program storage device readable by a machine tangibly embodying a program of instructions executable by the machine to perform a method for consumer driven marketing
(b) computer code for installation on a communication device;
(c) a merchant module enabling a merchant to manage rewards, rule, create games, and the like;
(d) a media capturing module for capturing multimedia of a plurality of merchant's product or service;
(e) a social module for enabling distribution of captured media to plurality of networks, the social module receiving plurality of feedbacks and communications on the captured media from a user; and
(f) a reward module using merchant created criterion and converting the feedback from social module into an incentive.

19. The system of claim 18 further comprises consumer module generating, on the fly, bar code to communicate user and/or consumer information, location information, reward information, information regarding a merchant, initial consumer rewards, and the like, or any combination thereof.

20. The system of claim 18, further comprises coupon module enabling a merchant to generate and communicate to a consumer plurality of coupons, coupon module enabling a consumer to displaying a digital coupon placed within a consumer account.
